(19) United States
(12) Patent Application Publication
(10) Pub. No.: US 2007/0293187 A1
(43) Pub. Date: Dec. 20, 2007

(54) Method and System for Enabling Location Based Wireless Communication Services

(75) Inventor: Leonard K. Pennock, Chandler, AZ (US)

Correspondence Address: MOTOROLA, INC., LAW DEPARTMENT, 1303 E. ALGONQUIN ROAD, SCHAUMBURG, IL, 60196, US

(73) Assignee: Motorola, Inc., Schaumburg, IL (US)

(21) Appl. No.: 11/424,292

(22) Filed: Jun. 15, 2006

(51) Int. Cl. H04M 11/04

(52) U.S. Cl. 455/404.2

(57) ABSTRACT

A method and system for enabling location based wireless communication services. The method comprises evaluating a predefined criterion corresponding to a mobile station. The method further comprises either allowing a wireless communication service to the mobile station, if the predefined criterion evaluates to true or denying the wireless communication service to the mobile station, if the predefined criterion evaluates to false.

### FIELD OF INVENTION

The present invention relates generally to a wireless communication system. More specifically, the invention relates to a method and system for enabling location based wireless communication services in a wireless communication network.

### BACKGROUND OF THE INVENTION

There exist methods and systems for regulating usage of mobile stations within designated areas in a wireless communication network. Conventionally, jammers are installed in and around a designated area to block wireless communication in the designated area. The jammers prevent the mobile stations from decoding the signals of a wireless communication network. Therefore, each mobile station present in the designated area is disconnected from the wireless communication network. The mobile stations experience zero signal or no service when they are present within the designated area. As a result, no mobile station can receives or initiate a call. Further, the communication is blocked for each mobile station irrespective of the profile corresponding to a mobile station.

The deployment of jammers is an expensive procedure and further, if there is a need to increase of decrease the coverage within designated areas, either the jammers need to be removed or additional jammers need to be added in the designated area. Therefore, modification of the coverage area, i.e., increase or decrease becomes a cumbersome process. Additionally, jammers can be used to block communication only for a predefined area, which corresponds to a jammer. Moreover, jammer blocks communication with emergency numbers, for example, hospital numbers and police number as well.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram showing an exemplary environment in which various embodiments of the present invention can function.

FIG. 2 illustrates a flow diagram of a method for enabling location based wireless communication services to at least one mobile station in accordance with an embodiment of the present invention.

FIG. 3 illustrates a system to enable location based wireless communication services to at least one mobile station in accordance with an embodiment of the present invention.

### DETAILED DESCRIPTION OF THE INVENTION

Before describing in detail embodiments that are in accordance with the present invention, it should be observed that the embodiments reside primarily in combinations of method steps and apparatus components related to a method and system for enabling location based wireless communication services to one or more mobile stations. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that embodiments of the invention described herein may be comprised of one or more conventional processors and unique stored program instructions that control the one or more processors to implement, in conjunction with certain non-processor circuits, some, most, or all of the functions of a method and system for enabling location based wireless communication services to one or more mobile stations in a wireless communication network in a defined environment described herein. The non-processor circuits may include, but are not limited to, a radio receiver, a radio transmitter, signal drivers, clock circuits, power source circuits, and user input devices. As such, these functions may be interpreted as steps of a method to provide cordless extension for a plurality of communication devices in a defined environment described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Generally speaking, pursuant to the various embodiments, the invention provides a system and method that enables a wireless communication network to identify geographical areas that can be provisioned to allow or deny various wireless communication services. The present invention provides a method for enabling location based wireless communication that can be customized for each mobile station. Further, the geographical areas that need to be provisioned for allowing or denying various wireless communication services can be adjusted without needing to deploy or remove any hardware. Those skilled in the art will realize that the above recognized advantages and other advantages described herein are merely exemplary and are not meant to be a complete rendering of all of the advantages of the various embodiments of the present invention.

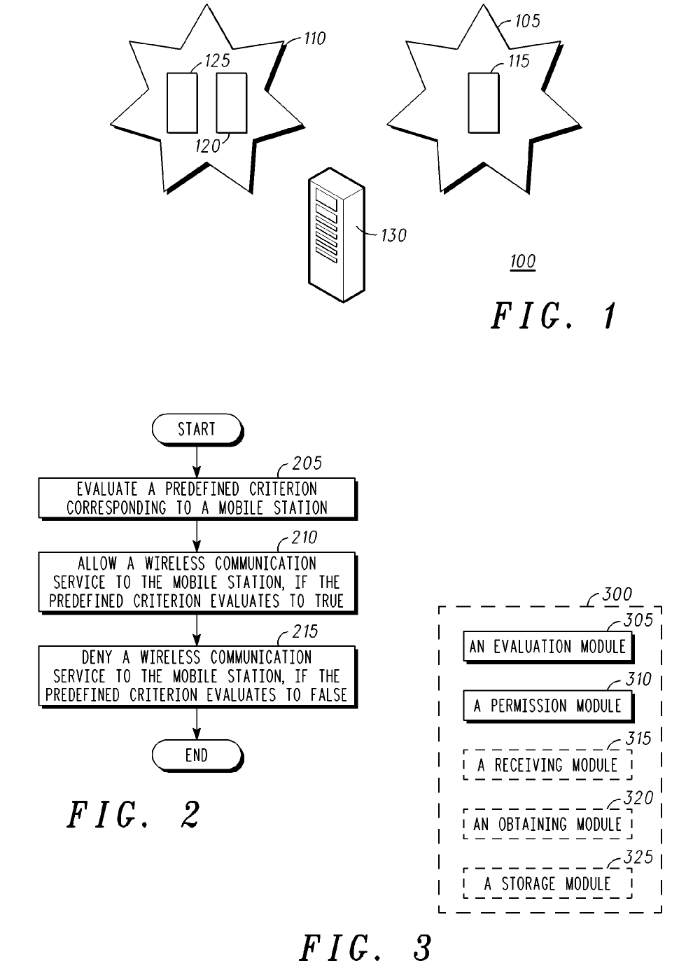

Referring now to the drawings, and in particular to FIG. 1, a block diagram showing an exemplary wireless communication network 100 in which various embodiments of the present invention can function. Those skilled in the art, however, will recognize and appreciate that the specifics of this illustrative example are not specifics of the present invention itself and that the teachings set forth herein are applicable in a variety of alternative settings. For example, since the teachings described do not depend on the number or type of mobile stations, servers and defined environments, they can be applied to any number or any type of mobile stations, servers and defined environments although only two mobile stations in one defined environment and one mobile station in another defined environment and a server are shown in this embodiment.

FIG. 1 depicts a defined environment 105 and a defined environment 110 in the wireless communication network 100. A mobile station 115 belongs to the defined environment 105 and the defined environment 110 includes a mobile station 120 and a mobile station 125. As such, other alternative implementations of using a plurality of mobile stations belonging to a plurality of defined environment are contemplated and are within the scope of the various teachings described. The defined environment 105 and the defined environment 110 where the mobile station 115 and the mobile station 120 and the mobile station 125 exist respectively can comprise a movie theater, a church, a hospital, a conference room or a terrorist risk area. The present invention proposes a method and a system, enabling a wireless communication network to identify geographical areas where the wireless communication services (both inbound and outbound) need to be blocked.

Referring to the embodiment depicted in FIG. 1, in a particular situation, the defined environment 105 is a geographical location such as a church where complete silence is maintained. In the defined environment 105 the wireless communication services (both inbound and outbound) is blocked with the help of a server 130 to the mobile station 115 belonging to the defined environment 105.

A mobile station is provided with an access to one or more wireless communication services based on a location information and a user-profile corresponding to the mobile station. The user-profile corresponds to a mobile station can be categorized as an exempt-user-profile or a non-exempt-user-profile. A mobile station corresponding to an exempt-user-profile has an unconditional access to the wireless communication services. Whereas a mobile station corresponding to a non-exempt-user-profile can be denied to accesses one or more wireless communication services based on the corresponding location-information. Referring now to FIG. 1, in another situation where the defined environment 110 is a movie theater where the server 130 blocks the wireless communication services (both inbound and outbound) to the mobile station 120, on the other hand, the wireless communication services are (both inbound and outbound) allowed by the server 130 to another mobile station 125 residing in the same defined environment 1 10. Those skilled in the art shall recognize that though the defined environment 110 remains the same, the wireless communication services to the mobile station 120 are denied as the user-profile corresponding to the mobile station 120 is a non-exempt-user-profile and the user-profile corresponding to the mobile station 125 is a exempt-user-profile therefore the mobile station 125 is allowed the wireless communication services. Thus, the wireless communication services can be allowed or denied to the mobile station based on a profile and a location information corresponding to the mobile station.

Turning now to FIG. 2, a flow diagram of a method for enabling location based wireless communication services to at least one mobile station, is shown in accordance with an embodiment of the present invention. In the communication network a plurality of mobile stations exist in various defined environments. The defined environments where the mobile stations exist can comprise a movie theater, a church, a hospital, a conference room or a terrorist risk area, where wireless communication services to a mobile station needs to be allowed or blocked for various reasons. The wireless communication services are either initiated by the mobile station or terminated to the mobile station.

A server corresponding to a wireless communication service provider receives a request from the mobile station for a wireless communication service. Upon receiving the request for the wireless communication service a location-information corresponding to the mobile station is obtained. At step 205, upon receiving the request for the wireless communication service, the request is evaluated based on a predefined criterion corresponding to the mobile station. In an embodiment of the present invention, the predefined criterion comprises of a user-profile corresponding to a user of the mobile station. A user-profile can be categorized as an exempt-user-profile or a non-exempt-user-profile based on the attributes of the user of the mobile station. A mobile station corresponding to an exempt-user-profile has an unconditional access to the wireless communication services. Whereas a mobile station corresponding to a non-exempt-user-profile can be denied to accesses one or more wireless communication services based on the corresponding location-information. The predefined criterion also comprises location-information corresponding to the mobile station of the user. The wireless communication services are denied in a provisioned-geographical-area based on the location-information of the mobile station.

It will be appreciated that a provisioned-geographical-area can be defined as a predefined-center-point and a predefined-radius-coverage-area around the predefined-center-point or it can be defined as predefined-boundary-points corresponding to a geographical location. Those skilled in the art will recognize that the wireless communication services can be denied in a provisioned-geographical-area for a predefined-time-interval.

At step 210, upon evaluation of the predefined criterion, if the predefined criterion evaluates to true, the wireless communication service is allowed to the mobile station. Contrarily at step 215, upon evaluation of the predefined criterion, if the predefined criterion evaluates to false, the wireless communication service is denied to the mobile station. Therefore, the wireless communication services can be allowed or denied to the mobile station based on profile and location information corresponding to the mobile station.

Referring now to FIG. 3, a system 300 to a system to enable location based wireless communication services to at least one mobile station in accordance with an embodiment of the present invention. The system comprises an evaluation module 305, a permission module 3 10, a receiving module 315, an obtaining module 320 and a storage module 325. The receiving module 315 receives a mobile station's request for a wireless communication service. Thereafter, the mobile station also sends its location information to the wireless communication network before initiating or terminating a call, the location information corresponding to the mobile station is obtained by an obtaining module 320.

Once the request is received, the evaluation module 305 evaluates the request received by the receiving module 315 based on a predefined criterion corresponding to the mobile station. The predefined criterion can be based on a user-profile and a location information corresponding to the mobile station. The storage module 325 stores a user-profile and a location information corresponding to each mobile station in the wireless communication network. In an embodiment of the present invention, a user-profile corresponding to a mobile station can be categorized as an exempt-user-profile or a non-exempt-user-profile. A mobile station corresponding to an exempt-user-profile has an unconditional access to the wireless communication services. Whereas a mobile station corresponding to a non-exempt-user-profile can be denied to accesses one or more wireless communication services based on the corresponding location-information. In an embodiment of the present invention, certain geographical areas can be identified, that needs to be provisioned to allow or deny wireless communication services. Once, the predefined criterion is evaluated for the mobile station, the permission module 310 allows or denies the wireless communication service to the mobile station based on the outcome of the evaluation. If the predefined criterion evaluates to true, the permission module 310 allows the mobile station to access the wireless communication service. On the other hand, if the predefined criterion evaluates to false, the permission module denies the wireless communication service to the mobile station. Therefore, the system 300 facilitates a wireless communication network to allow or deny one or more wireless communication services to one or more mobile stations based on a user-profile and a location information corresponding to one or more mobile stations.

The various embodiments of the present invention provide a system and method that enables a wireless communication network to identify geographical areas where the wireless communication services needs to be conditionally allowed or denied. Further, the present invention provides a method and system for allowing or denying wireless communication services to one or more mobile communication services based on a user-profile and a location information corresponding to a mobile station. The geographical areas where the wireless communication services needs to be conditionally allowed or denied can be adjusted without needing to deploy or remove any hardware. Further, the location based wireless communication services system is enabled for a network rather than a mobile station.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for enabling location based wireless communication services to at least one mobile station in a wireless communication network, the method comprising:
evaluating a predefined criterion corresponding to a mobile station;
allowing a wireless communication service to the mobile station, if the predefined criterion evaluates to true; and
denying a wireless communication service to the mobile station, if the predefined criterion evaluates to false.

2. The method of claim 1 further comprising receiving a request from the mobile station for a wireless communication service, wherein the predefined criterion is evaluated in response to the request.

3. The method of claim 2 further comprising obtaining a location-information corresponding to the mobile station.

4. The method of claim 1, wherein the predefined criterion comprises at least one of:
a user-profile corresponding to a user of the mobile station being an exempt-user profile, wherein exempt-user-profile has an unconditional access to the wireless communication services; and
location-information corresponding to the mobile station of the user being different from each provisioned-geographical-area, wherein the wireless communication services are denied in the each provisioned-geographical-area.

5. The method of claim 1, wherein the wireless communication is initiated by the mobile station.

6. The method of claim 1, wherein the wireless communication is terminated to the mobile station.

7. The method of claim 4, wherein the wireless communication services are denied in a provisioned-geographical-area for a predefined-time-interval.

8. The method of claim 4, wherein a provisioned-geographical-area can be defined as a predefined-center-point and a predefined-radius-coverage-area around the predefined-center-point.

9. The method of claim 4, wherein a provisioned-geographical-area can be defined as predefined-boundary-points corresponding to a geographical location.

10. A system for enabling location based wireless communication services to at least one mobile station in a wireless communication network, the system comprising:
an evaluation module, the evaluation module evaluating a predefined criterion corresponding to a mobile station; and
a permission module, the permission module configure to:
allow a wireless communication service to the mobile station, if the predefined criterion evaluates to true; and
deny a wireless communication service to the mobile station, if the predefined criterion evaluates to false.

11. The system of claim 10 further comprising:
a receiving module, the receiving module receiving a request from the mobile station for a wireless communication service, wherein the predefined criterion is evaluated in response to the request.

12. The system of claim 11 further comprising:
an obtaining module, the obtaining module obtaining a location-information corresponding to the mobile station.

13. The system of claim 12 further comprising:
a storage module, the storage module storing a user-profile corresponding to a user of
a mobile station and a location-information corresponding to the mobile station of the user.
